(19) United States
(12) Patent Application Publication
(10) Pub. No.: US 2015/0075116 A1
(43) Pub. Date: Mar. 19, 2015

(54) CARTRIDGE FOR A PLANT-TREATMENT PRODUCT SPRAYER, AND RELATED METHODS

(71) Applicants: Lorelei Hepburn, Ajax (CA); Jon Barnes, Ajax (CA)

(72) Inventors: Lorelei Hepburn, Ajax (CA); Jon Barnes, Ajax (CA)

(21) Appl. No.: 14/027,853

(22) Filed: Sep. 16, 2013

(51) Int. Cl. A01C 23/04; A01M 7/00; B65D 85/00

(52) U.S. Cl. CPC A01C 23/047; B65D 85/00; A01M 7/0085
USPC 53/431; 206/525

(57) ABSTRACT

A cartridge for a liquid reservoir of a plant-treatment product sprayer is disclosed. The cartridge includes a liquid permeable pouch defining a pre-sealed internal volume, and a plant-treatment formulation in the internal volume. A method of providing a plant-treatment formulation to a liquid reservoir of a plant-treatment product sprayer, and a cartridge for dispensing a plant-treatment formulation are also disclosed.

### FIELD

The present disclosure relates to the field of cartridges for plant-treatment product sprayers and related methods.

### INTRODUCTION

Plant-treatment products, such as pesticides, fertilizers, and other soil amendments, are commonly used to enhance the growth of plants for which they are applied. In recent years, consumer environmental awareness and government regulation against toxic chemicals have contributed to a rise in demand for natural, organic plant treatment products, and especially pesticides.

### SUMMARY

In a first aspect, there is a cartridge for a liquid reservoir of a plant-treatment product sprayer. The cartridge may comprise a liquid permeable pouch defining a pre-sealed internal volume, and a plant-treatment formulation in the internal volume.

In some embodiments, the plant-treatment formulation may comprise nematodes and a carrier formulation.

In some embodiments, the liquid permeable pouch may comprise a plurality of pores which provide the liquid permeability of the pouch, and each of the plurality of pores may be sized small enough to prevent passage of particles large enough to clog the sprayer.

In some embodiments, a size of each of the plurality of pores may be less than 2 mm.

In some embodiments, a size of each of the plurality of pores may be between 1.5 mm and 2 mm.

In some embodiments, the pouch may be flexible.

In some embodiments, the cartridge may further comprise a string extending from the liquid permeable pouch for handling the cartridge without touching the pouch.

In some embodiments, the pouch may comprise a woven material of fine filaments.

In some embodiments, the pouch may be biodegradable and may comprise polylactic acid.

In some embodiments, the nematodes may comprise entompathogenic nematodes.

In some embodiments, the plant-treatment formulation may comprise at least one of a pesticide, a fertilizer, and a soil amendment.

In some embodiments, the carrier formulation may comprise vermiculite.

In some embodiments, the cartridge may further comprise a vapor-permeable packaging enclosing the pouch, the pouch being removable from the packaging prior to use.

In some embodiments, the vapor-permeability of the packaging may be provided by a hole pierced in the packaging and a remainder of the packaging may be vapor-impermeable,

In another aspect, there is provided a method of providing a plant-treatment formulation to a liquid reservoir of a plant-treatment product sprayer. The method may comprise depositing a cartridge into the liquid reservoir, the cartridge including a liquid permeable pouch defining a pre-sealed internal volume, and a plant-treatment formulation in the internal volume; and at least partially filling the liquid reservoir with a liquid, the liquid permeating the pouch and carrying the plant-treatment formulation out of the pouch.

In some embodiments, the method may further comprise agitating the cartridge at least partially submerged in the liquid to encourage the plant-treatment formulation to exit the pouch with the liquid.

In some embodiments, the method may further comprise before depositing the cartridge, removing the cartridge from a vapor-permeable packaging enclosing the pouch.

In some embodiments, the plant-treatment formulation may comprise nematodes and a carrier formulation.

In some embodiments, the plant-treatment formulation may comprise at least one of a pesticide, a fertilizer, and a soil amendment.

In some embodiments, the liquid permeable pouch may comprise a plurality of pores which provide the liquid permeability of the pouch, and each of the plurality of pores is sized small enough to prevent passage of particles large enough to clog the sprayer.

In another aspect, there is provided a cartridge for dispensing a plant-treatment formulation. The cartridge may comprise a pouch containing the plant-treatment formulation, the plant-treatment formulation including one or more carrier components and one or more active components, the pouch configured to filter the one or more carrier components and allow passage of the one or more active components.

In some embodiments, the one or more active components includes a plurality of nematodes.

### DRAWINGS

FIG. 1 shows a side elevation view of a prior art plant-treatment product sprayer;

FIG. 2 shows a front elevation view of a cartridge for a liquid reservoir of a plant-treatment product sprayer, in accordance with at least one embodiment;

FIG. 3 shows a top view of the cartridge of FIG. 2, in accordance with at least one embodiment;

FIG, 4 shows a cross-sectional view of the cartridge of FIG. 2, taken along the line 4-4 in FIG. 2;

FIG. 5 shows the cartridge of FIG. 2 deposited into the liquid reservoir of the plant-treatment product sprayer of FIG. 1;

FIG. 6 shows a perspective view of a cartridge for a liquid reservoir of a plant-treatment product sprayer, in accordance with another embodiment;

FIG. 7 shows the cartridge of FIG. 6 in a compacted state, in accordance with at least one embodiment;

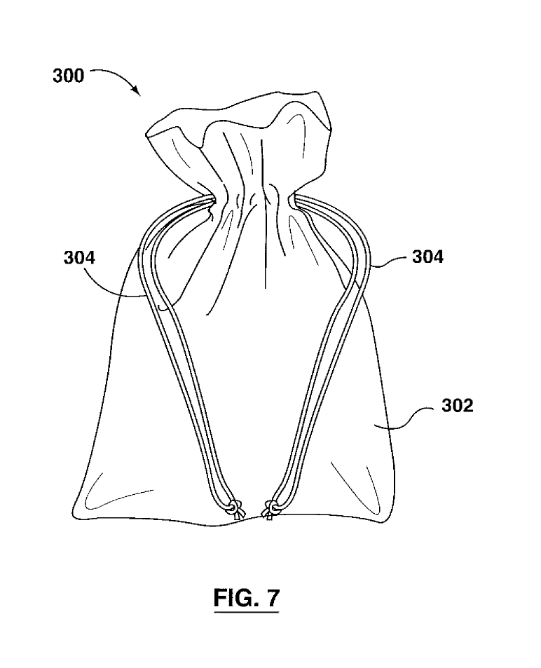

FIG. 8 shows the cartridge of FIG. 2 in a plastic bag;

FIG. 9 shows a side view of the cartridge of FIG. 2 being deposited into the liquid reservoir of a plant-treatment product sprayer;

FIG. 10 shows a flowchart illustrating a method of providing a plant-treatment product to a liquid reservoir of a plant-treatment product sprayer, in accordance with at least one embodiment;

FIG. 11 shows a perspective view of a back pack sprayer, in accordance with at least one example embodiment; and

FIG. 12 shows a side elevation view of a trailer tank sprayer, in accordance with at least one example embodiment.

### DESCRIPTION OF VARIOUS EMBODIMENTS

Various apparatuses or processes will be described below to provide an example of an embodiment of each claimed subject matter. No embodiment described below limits any claimed subject matter and any claimed subject matter may cover processes or apparatuses that differ from those described below. The claimed subject matter are not limited to apparatuses or processes having all of the features of any one apparatus or process described below or to features common to multiple or all of the apparatuses or processes described below. It is possible that an apparatus or process described below is not an embodiment that is recited in any claimed subject matter. Any subject matter disclosed in an apparatus or process described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the example embodiments described herein in any way, but rather as merely describing the implementation of various embodiments as described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

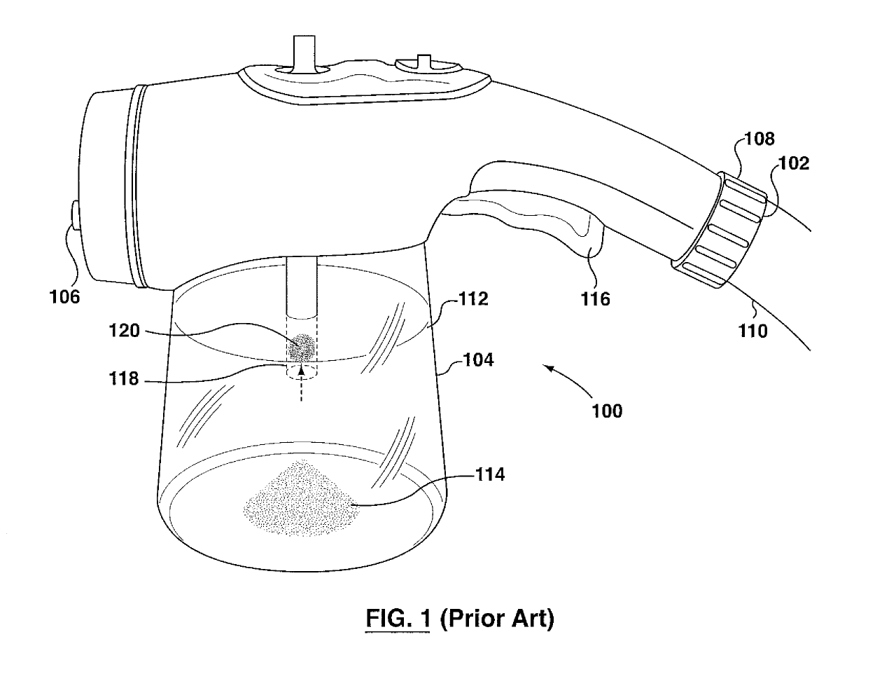

FIG. 1 shows a side elevation view of a prior art plant-treatment product sprayer 100 for applying plant-treatment formulation to soil and/or plants for the benefit of plants. Some examples of plant-treatment product sprayers include, but are not limited to, Scotts® Miracle Gro Feeder®, Gilmour® Fertilizing Feeder Model 405, RL Flo-Master Back Pack Sprayer Model 614, and Agrimax Professional Trailer Sprayer Model STT5512V, Daltmeier (50-500 gallon) Skid Mounted Sprayer, and Kings 200 Gallon Pest Control Skid Sprayer.

As used herein for the various embodiments and in the claims, the term “plant” includes all species of plantae, bacteria, and fungi. Further, as used herein and in the claims, the term “plant treatment formulation” includes pesticides (including but not limited to water soluble and water insoluble pesticides, herbicides, insecticides, fungicides and plant growth regulators, miticides), microbes, fertilizers, and soil amendments. One example plant-treatment formulation includes a mixture of nematodes and a carrier formulation. Certain species of nematodes (e.g., entompathogenic nematodes), are used in organic pesticides because they are hostile to some varieties of garden pests. In sonic embodiments, the carrier formulation provides the nematodes in a storage medium designed to mimic their typical soil habitat. The carrier may also keep the nematodes in solution during the storage period prior to release.

In general, a plant-treatment product sprayer 100 typically receives liquid (e.g. water) from a liquid source (e.g. a water tank or municipal water supply), mixes the liquid with a plant-treatment formulation, and sprays the mixture of liquid and plant-treatment formulation onto targeted soil pests and/or plants. In the example shown, plant-treatment product sprayer 100 includes a liquid inlet 102, a liquid reservoir 104, and an outlet nozzle 106 Liquid inlet 102 in this example is configured to fluidly couple with a liquid source for receiving liquid therefrom. As shown, liquid inlet 102 includes a coupling 108 for connecting to a hose 110 of a liquid source. In other examples, plant-treatment product sprayer 100 includes an integral hose 110 which can be coupled to, or is itself integral with, a liquid source.

In use, liquid reservoir 104 of plant-treatment product sprayer 100 is removed, at least partially filled with liquid 112 (e.g. water) and plant-treatment formulation 114, and then reinserted back into its proper working location for use. Next in this example, plant-treatment product sprayer 100 is activated, whereby liquid 112 from a liquid source (not shown) enters plant-treatment product sprayer 100 at liquid inlet 102, flows into liquid reservoir 104, and entrains plant-treatment formulation 114, before spraying out of outlet nozzle 106. In the example shown, plant-treatment product sprayer 100 includes a lever 116 for selectively activating plant-treatment product sprayer 100. Lever 116 can be engaged by pulling upwards and released, in this example, to selectively open and close the liquid flow path between liquid inlet 112 and liquid reservoir 104.

In the example shown, the liquid flow path between liquid reservoir 104 and nozzle 106 includes an uptake conduit 118 which extends into liquid reservoir 104. In this example, the uptake conduit 118 is a straw. When plant-treatment product sprayer 100 is activated in this example, a mixture of liquid 112 and plant-treatment formulation 114 flows through uptake conduit 118 before spraying out of outlet nozzle 106. Different plant-treatment product sprayers may be configured differently and may not include an uptake conduit 118 or may have a different structure.

As mentioned above, liquid reservoir 104 is partially pre-filled with plant-treatment formulation 114. In some cases, loose plant-treatment formulation 114 is poured into liquid reservoir 104. However, some plant-treatment formulations 114 include components, such as clay, vermiculite, coir, peat, or polymers, etc., which have been found to form clumps and clog the liquid flow path between liquid reservoir 104 and nozzle 106. For example, FIG. 1 shows a clump 120 of plant-treatment formulation 114 creating a blockage in uptake conduit 118. When the liquid flow path between liquid reservoir 104 and outlet nozzle 106 is clogged, the flow rate through this liquid flow path and the spray out of outlet nozzle 106 is reduced, or worse halted. In some cases, restoring the flow rate inconveniently requires the user to deactivate plant-treatment product sprayer 100, remove the liquid reservoir 104 and manually clear the blockage.

Some plant-treatment formulations 114 lose effectiveness when overexposed to liquid 112. For example, some plant-treatment formulations include living organisms, such as nematodes. However, some organisms, such as nematodes, will drown if they remain in liquid for too long (e.g. 30 minutes or more). In some cases, delays created by the blockages described above, can cause some of plant-treatment formulation 114 to remain in liquid 112 for too long. In turn, there may be a reduction in the effectiveness of the remaining plant-treatment formulation 114 as the living organisms therein drown.

Some components of plant-treatment formulations are harmful to humans. For example, some plant-treatment formulations are carcinogenic if inhaled, and/or corrosive to skin-contact. Accordingly, it may be advisable to wear protective equipment, such as gloves and a respiratory device when handling loose plant-treatment formulation to mitigate the risk of harmful exposure. However, equipping such protective equipment may be inconvenient for some users.

Some components of plant-treatment formulations are sensitive to bacteria. For example, nematodes are sensitive to bacteria that are commonly found on human hands as well as certain types of mould. Consequently, there is a high mortality of nematodes observed when they are handled with bare hands. Dead nematodes make for ineffective components of a plant-treatment formulation. Accordingly, it may be advisable to wear protective gloves when handling loose plant-treatment formulation which includes sensitive organisms (e.g. nematodes). However, equipping protective gloves may be inconvenient for some users.

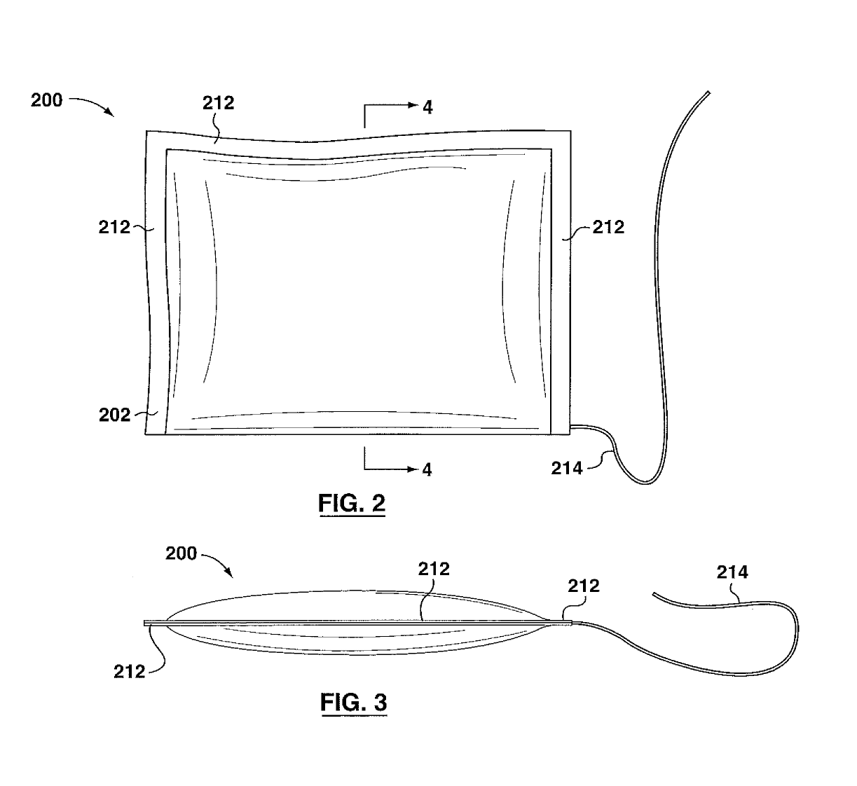

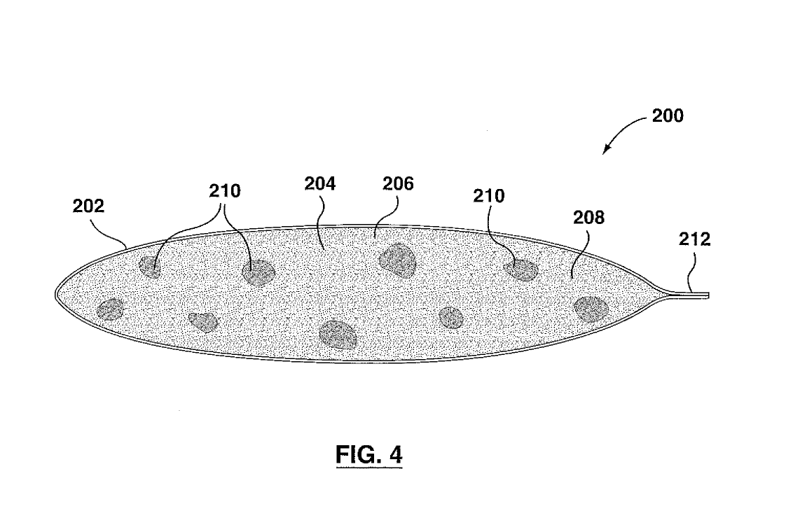

Reference is now made to FIGS. 2-4. FIG. 2 shows a front elevation view of a cartridge 200 for a liquid reservoir of a plant-treatment product sprayer, in accordance with at least one embodiment. FIG. 3 shows a top view of cartridge 200, in accordance with at least one embodiment. FIG. 4 shows a cross-sectional view of cartridge 200 taken along the line 4-4 in FIG. 2.

In the example shown, cartridge 200 includes a liquid permeable pouch 202, which defines an internal volume 204. A plant-treatment formulation 206, in this example, is contained by pouch 202 in the internal volume 204. In some embodiments, cartridge 200 is pre-seated (e.g. during manufacturing of cartridge 200) before it is sold to an end-user. In alternative embodiments, cartridge 200 and plant-treatment formulation 206 are separately provided to end-users. In these embodiments, the end-user at least partially fills internal volume 204 with plant-treatment formulation 206 before use

The pouch 202 advantageously allows the nematodes to be kept away from human contact to help keep bacteria levels low making a better environment for the nematodes and to ensure better storage and use.

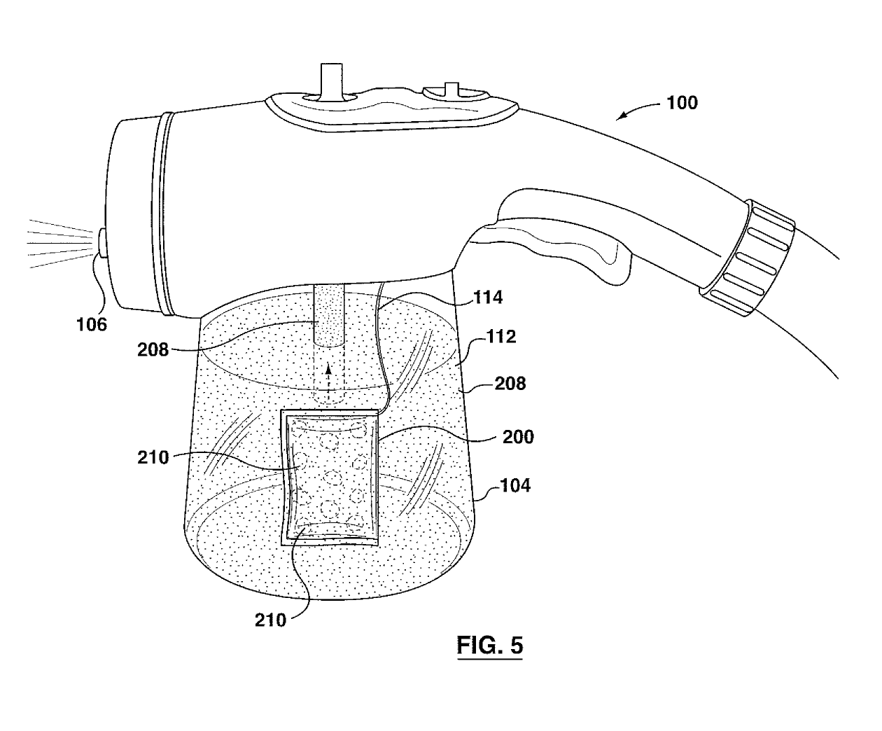

As shown in FIG. 5, cartridge 200 may be deposited into liquid reservoir 104 of plant-treatment product sprayer 100 instead of depositing a loose plant-treatment formulation, as was shown in FIG, 1. In contrast with handling loose plant-treatment formulation, cartridge 200 may provide a safer way of transferring plant-treatment formulation 206 into liquid reservoir 104. For example, liquid permeable pouch 202 may provide an effective barrier between plant-treatment formulation 206 and a user. This may reduce user-exposure to plant-treatment formulation 206 lessening the risk of harm to the user and to components of the plant-treatment formulation 206 Plant-treatment formulation 206 may be less likely to make skin-contact with a user or become airborne when contained in pouch 202. Still, in some embodiments, loose plant-treatment formulation 206 is deposited into liquid reservoir 104 in addition to cartridge 200.

Referring now to FIGS. 1-5, pouch 202 is permeable to a mixture of liquid 112 and small particles 208 of plant-treatment formulation 206, in the example shown. This may permit a mixture of liquid 112 and small particles 208 to flow out of pouch 202 and subsequently spray out of outlet nozzle 106. In some embodiments, pouch 202 is not permeable to clumps 210 of plant-treatment formulation 206 that are large enough to clog plant-treatment sprayer 100.

Pouch 202 includes a plurality of pores, in some embodiments, which provide the liquid permeability of pouch 202. In some examples, the pores are sized large enough to allow passage of liquid 112 and small particles 208, and sized small enough to prevent passage of clumps 210. In some cases, clumps 210 break apart into small particles 208 when forced by liquid 112 through the pores of pouch 202, which cannot accommodate large clumps. All of the pores of pouch 202 are smaller than 2 mm across in at least some embodiments. This may prevent clumps 210 having a diameter of 2 mm or more from passing through pouch 202 in these cases.

As mentioned above, some plant-treatment formulations include nematodes, which may be effective as an organic fertilizer. Accordingly, it may be desirable for the pores of pouch 202 to be sized large enough for nematodes to pass. Typically, juvenile nematodes have a length of between 0.4 mm and 1.5 mm. Therefore, in some examples, all of the pores of pouch 202 are larger than 1.5 mm across. In one such example, all of the pores of pouch 202 are between 1.5 mm and 2 mm across.

Further, some plant-treatment formulations include carrier components and active components. The active components may provide the intended plant-treatment effect when applied to, e.g. targeted plants. In some cases, the carrier components may enhance the shelf-life of the active components, or may help to retain the active components until they are applied to, e.g. targeted plants. For example, some plant-treatment formulations include active components such as nematodes, and a carrier formulated to emulate the natural habitat of the nematodes. This may help to reduce the mortality rate of the nematodes. In some embodiments, the pores of pouch 202 are sized to filter the carrier components of plant-treatment formulation 206, and allow passage of the active components of plant-treatment formulation 206. This may permit substantially all of the active components to pass through pouch 202, for mixing with liquid 112 and eventually spraying out of outlet nozzle 106, while retaining substantially all of the carrier ingredients within pouch 202.

In some embodiments, pouch 202 is more permeable when wet, than when dry. This may help to prevent plant-treatment formulation 206 from escaping pouch 202 before it makes contact with liquid 112 inside liquid reservoir 104, such as during shipping, storage on store-shelves, or user-handling. In some embodiments, the pores of pouch 202 are enlarged by contact with liquid 112. In some embodiments, the pressure exerted by liquid 112 as it passes through pouch 202 breaks plant-treatment formulation 206 into small particles 208 which are small enough to pass through the pores of pouch 202. Still, in alternative embodiments, the permeability of pouch 202 to plant-treatment formulation 206 may be relatively the same when pouch 202 is dry and when pouch 202 is wet.

In some embodiments, pouch 202 is less permeable to dry plant-treatment formulation than to wet plant-treatment formulation. This may help to prevent dry plant-treatment formulation 206 from escaping pouch 202 before it makes contact with liquid 112 inside liquid reservoir 104, such as during shipping, storage on store-shelves, and user-handling. In some examples, one or more components of plant-treatment formulation 206 dissolves or decomposes from contact with liquid 112. Still, in alternative embodiments, the permeability of pouch 202 to dry and wet plant-treatment formulation 206 is relatively the same.

In various embodiments, pouch 202 is made from one or more of a woven material, a non-woven material, and a film. The material of pouch 202 in some cases includes a web of fine-filaments. In some cases, the web includes fine-filaments woven in a weave pattern, such as a basket-weave for example. The fine-filaments may include one or more of natural fibers, synthetic fibers and combinations thereof.

In some embodiments, the material of pouch 202 is biodegradable. For example, the material of pouch 202 may include a biodegradable bioplastic. Bioplastics include starch blends made from thermo-plastically modified starch, biodegradable polymers, polyesters, and polyhydroxy-alkanoate (PHA). Polylactic acid is one example of suitable polyester bioplastic that is both compostable and biodegradable. Polylactic acid, and some other biodegradable bioplastics may provide pouch 202 with a soft, textile-like appearance and feel. Other suitable biopiastics include starches (corn, potato and/or rice), cellulose and soy proteins. Still, in alternative embodiments, the material of pouch 202 may not be biodegradable, and does not have a soft textile-like appearance and feel. For example, the material of pouch 202 may be made from metal. Pouch 202, in some examples, is made from a wire mesh. In other embodiments, pouch 202 is made from a plant-based material, or mixtures of plant-based and artificial materials. The material of pouch 202, in some examples, includes one or more of paper (e.g. filter paper), bamboo, cotton, polyester, and nylon or some other combinational filter material.

In some embodiments, cartridge 200 is flexible. This may permit cartridge 200 to be inserted into liquid reservoirs having different sizes, shapes and differently sized and shaped openings. Still, in other embodiments cartridge 200 is rigid and not flexible.

In some embodiments, cartridge 200 contains a pre-measured quantity of plant-treatment formulation 206. The pre-measured quantity, in some examples, corresponds to an ideal quantity for plant-treatment product sprayers of a certain (e.g. standard) size, or else a specific model of plant-treatment product sprayer. This may be easier and faster than determining, measuring, and pouring loose plant-treatment formulation 114 into the liquid reservoir of a plant-treatment product sprayer 100.

According to some embodiments, certain cartridges 200 are sized for small household plant-treatment product sprayers, and certain other cartridges 200 are sized for large industrial plant-treatment product sprayers. In either case, the cartridge 200 is flexible and/or sized to fit into the opening of the reservoirs for different types of sprayers. An example of a cartridge 200 sized for household plant-treatment product sprayers measures about 6 cm in width, 8 cm in height, and 2 cm in depth. In some examples, a cartridge 200 of this size includes plant-treatment formulation having about 25 million nematodes. An example of a cartridge 200 sized for industrial plant-treatment product sprayers measures about 12 cm in width, 25 cm in height, and 10 cm in depth. In some examples, a cartridge 200 of this size includes plant-treatment formulation having about 250 million nematodes.

In some embodiments, cartridge 200 is a single-use product that is disposed after the plant-treatment product inside has been expended (e.g. sprayed out of a nozzle of a plant-treatment sprayer). In embodiments where cartridge 200 is biodegradable, an expended cartridge 200 may be disposed of in a compost bin, into a garden, or a municipal organic-waste bin (a “green” bin). In some embodiments, cartridge 200 includes a reusable, refillable, and recloseable pouch 202. In one example, pouch 202 can be opened, refilled with loose plant-treatment formulation, and then reclosed.

In the example shown, cartridge 200 has a substantially rectangular front profile. However, cartridge 200 can be formed in any shape, such as spherical, pyramidal, and cubical for example. Cartridge 202 may be manufactured by depositing a quantity of plant-treatment formulation on a web of pouch-material, folding the pouch-material over the plant-treatment formulation and itself, and then sealing overlapping edges 212. Edges 212 are sealed by any suitable means, such as melt-bonding and/or using adhesive and/or using appropriate stitching or sealing method.

In the example shown, cartridge 200 has a string 214. As shown, string 214 is coupled to pouch 202. String 214 may permit a user to manipulate cartridge 200 (e.g. deposit cartridge 200 into liquid reservoir 104, and/or agitate cartridge 200 in liquid reservoir 104, etc.) without directly touching pouch 202. This may further reduce user-exposure to plant-treatment formulation 206 to the benefit of the user's health and the effectiveness of the plant-treatment formulation 206. Still, in alternative embodiments, cartridge 200 does not have a string 214, and a user may manipulate cartridge 200 by direct handling of pouch 202. However, the string 214 may be useful for larger sized cartridges.

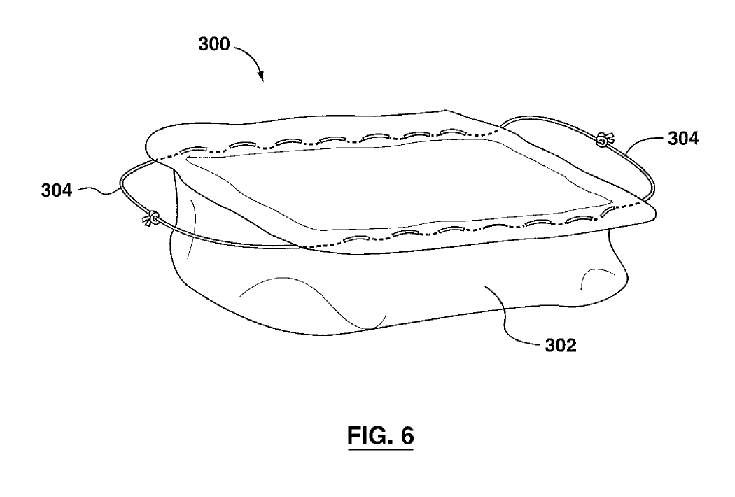

FIG. 6 shows a perspective view of a cartridge 300 for a liquid reservoir of a plant-treatment product sprayer, according to another embodiment. In the example shown, cartridge 300 includes a pouch 302, and drawstrings 304 coupled to pouch 302. Drawstrings 304 may permit pouch 302, which contains a volume of plant-treatment formulation, to be reconfigured into a more compact shape for depositing into the liquid reservoir of a plant-treatment product sprayer.

In the example shown, when cartridge 300 is in a relaxed state, it is shaped wide and long with a narrow depth. In some embodiments, drawstrings 304 are fastened to pouch 302 such that they collapse the shape of cartridge 300 when drawn. FIG, 7 shows an example of cartridge 300 in a compacted state after drawstrings 304 have been drawn. A relaxed state that is wide and long with a narrow depth may in some cases provide stability to a stack of cartridges 300. It may be desirable to stack cartridges 300 during shipping and storage, for example. However, in such a relaxed state, cartridge 300 may be too bulky to fit easily into some liquid reservoirs. Thus, it may be convenient to draw on drawstrings 304 to provide cartridge 300 with a more compact shape which may be more easily deposited into the liquid reservoirs of some plant-treatment product sprayers. Still, in alternative embodiments, cartridge 300 does not include drawstrings 304.

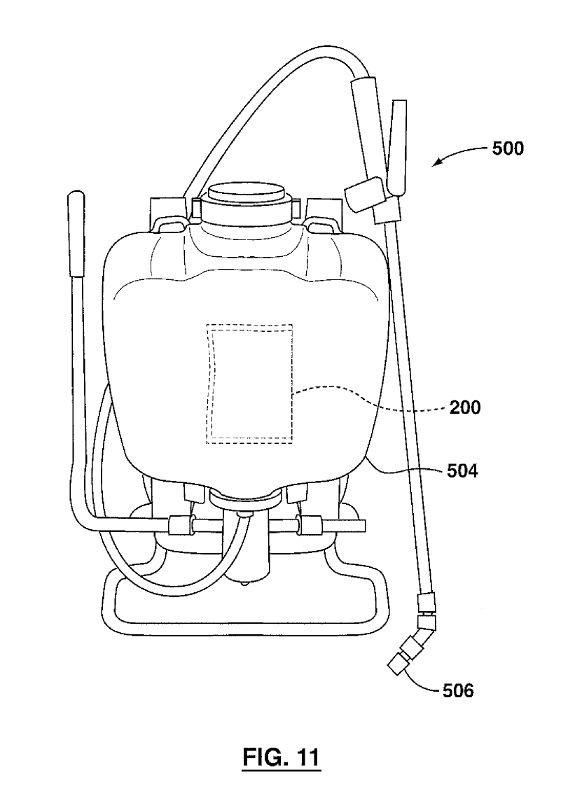

FIG. 11 shows a perspective view of a back pack sprayer 500, in accordance with at least one embodiment. In the example shown back pack sprayer 500 includes a liquid reservoir 504, and an outlet nozzle 506. As shown, a cartridge 200 has been inserted into liquid reservoir 504. The cartridge 200 that is shown FIG. 11 may have different dimensions and carry a different amount of plant treatment formulation compared to the other cartridges shown and described herein. In use plant-treatment formulation from cartridge 200 mixes with liquid inside liquid reservoir 504, and the mixture is sprayed out of outlet nozzle 506.

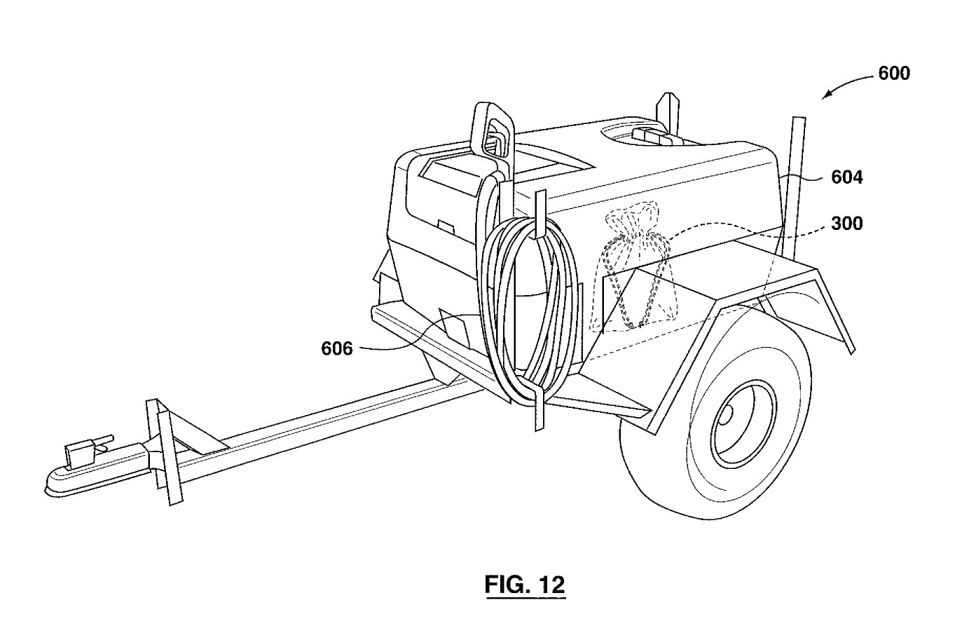

FIG. 12 shows a side elevation view of a trailer tank sprayer 600, in accordance with at least one embodiment. In the example shown trailer tank sprayer 600 includes a liquid reservoir 604, and an outlet hose 606. As shown, a cartridge 300 has been inserted into liquid reservoir 604. In use, plant-treatment formulation from cartridge 300 mixes with liquid inside liquid reservoir 604, and the mixture is delivered to an outlet nozzle (not shown) via outlet hose 606.

In some embodiments, pouch 202 is made of vapor-permeable material. This may permit ambient air to circulate through pouch 202. Some plant-treatment formulations include living organisms, such as nematodes, which breathe. During extended storage, these living organisms may perish prematurely if pouch 202 is vapor impermeable, leading to a shorter product shelf life, and reduced effectiveness of the plant-treatment formulation. Moreover, some plant-treatment formulations are sensitive to moisture, and/or prone to molding if exposed to excessive moisture during storage. This may also lead to a shorter product shelf life, and reduced effectiveness of the plant-treatment formulation. A vapor-permeable pouch 202 may in some cases permit ambient air to circulate through pouch 202 to allow organisms in the plant-treatment formulation to breathe, and to carry away moisture accumulated in pouch 202. Still, in alternative embodiments, pouch 202 is air-impermeable, at least when pouch 202 is dry.

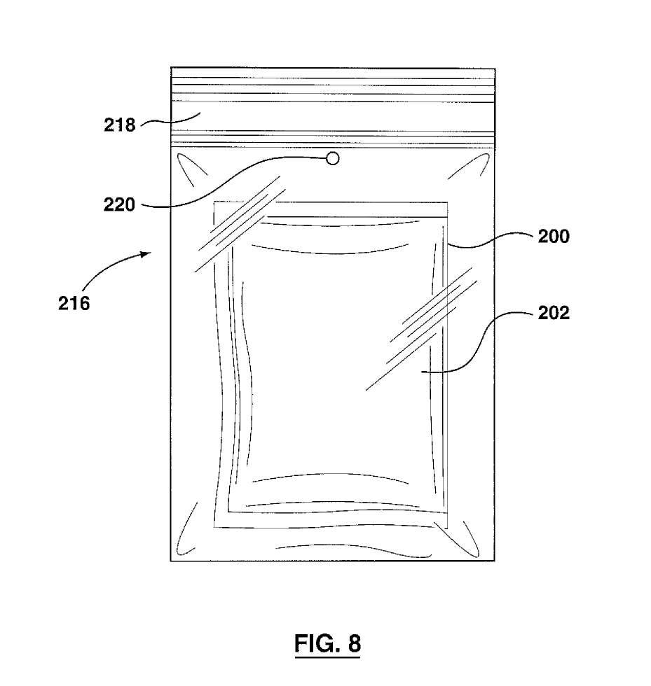

In some embodiments, one or more cartridges 200 is provided in packaging. FIG. 8 shows an example of a cartridge 200 provided in a plastic bag 216. In the example shown, plastic bag 216 includes a reclosable opening 218. Opening 218 may be normally closed during shipping and storage of plastic bag 216, and then opened to remove cartridge 200 before use. In alternative embodiments, plastic bag 216 is permanently sealed. In some examples, plastic bag 216 may be torn or cut open to access cartridge 200. Although, the illustrated embodiment includes packaging made of transparent plastic, alternative embodiments include both opaque and transparent packaging, and packaging made of any one or more of a variety of materials including, for example, paper, nylon, cotton, silk, and metal.

As discussed above, it may be beneficial for cartridge 200 to be vapor-permeable (e.g. to allow plant-treatment formulation to breathe, and to reduce moisture accumulation). Similarly, it may be beneficial for the packaging of cartridge 200 to be vapor-permeable. This may permit ambient air, from outside of the packaging, to circulate through a vapour-permeable pouch 202, located inside of the packaging. In the example shown, the vapor-permeability of plastic bag 216, when recloseable opening 218 is closed, is provided by a hole 220 pierced in the plastic bag 216. The remainder of plastic bag 216, in this example, is vapor-impermeable. In other embodiment, the material of the packaging is naturally vapor permeable (e.g. cotton). Still, in alternative embodiments, the packaging of cartridge 200 is substantially air-impermeable. These various embodiments help control too much moisture from building up by allowing for some air flow so that the contents of the pouch 202 can move and breathe.

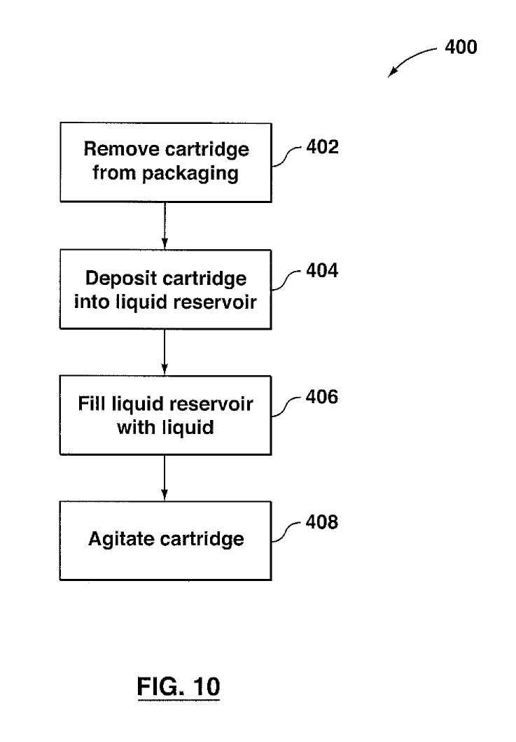

According to at least one embodiment, there is a use of cartridge 200 for providing plant-treatment formulation to a liquid reservoir of a plant-treatment product sprayer 100, wherein the cartridge 200 includes a liquid permeable pouch 202 containing a plant-treatment formulation 206. FIG. 10 shows a flowchart illustrating a method 400 of providing a plant-treatment product to a liquid reservoir of a sprayer, in accordance with at least one embodiment. Although the flowchart shows certain acts performed in a certain order, in some embodiments, method 400 may omit one or more of the acts shown, and/or includes one or more additional acts not shown. Moreover, in some embodiments, one or more of the acts of method 400 are practiced in an order that is different from that shown, and/or two or more of the acts of method 400 are practiced simultaneously.

For clarity, method 400 is described with reference to a cartridge 200, and a plant-treatment product sprayer 100. However, in alternative embodiments, method 400 is practiced using other suitable apparatus.

At 402, cartridge 200 is removed from packaging. In some embodiments, the packaging is a vapor-permeable packaging, such as plastic bag 216, which includes a hole 220. In one example, removing cartridge 200 from plastic bag 216 includes opening up recloseable opening 218 and then taking cartridge 200 out of plastic bag 216 through the opened opening 218. In alternative embodiments, cartridge 200 is not enclosed in packaging and method 400 does not include act 402.

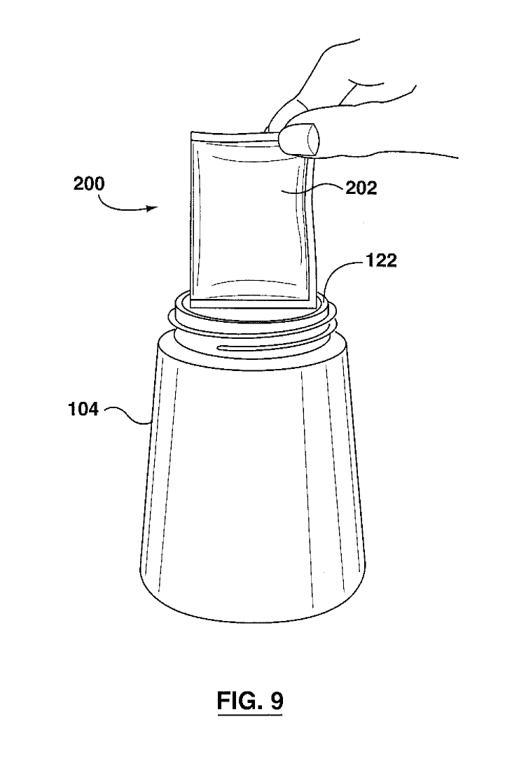

At 404, cartridge 200 is deposited into a liquid reservoir 104 of a plant-treatment product sprayer 100. FIG. 9 shows a side view of cartridge 200 being deposited into liquid reservoir 104 through mouth 122 of liquid reservoir 104. As shown, cartridge 200 includes a pre-measured quantity of plant-treatment formulation. In some cases, depositing a cartridge 200 of pre-measured quantity of plant-treatment formulation is easier and faster than determining, measuring, and pouring loose plant-treatment formulation into liquid reservoir 104.

In the example shown, pouch 202 of cartridge 200 is grasped directly by the user. However, in some cases, pouch 202 provides an effective barrier between the plant-treatment formulation that is contained inside the pouch 202 and the user. In these cases, pouch 202 may reduce user-exposure to the plant-treatment formulation to the benefit of the user's health and the effectiveness of the plant-treatment formulation.

In some embodiments, cartridge 200 includes a string (not shown). In these embodiments, depositing cartridge 200 can include using the string to lower cartridge 200 through mouth 122 of liquid reservoir 104. This may further reduce user-exposure to the plant-treatment formulation to the benefit of the user's health and the effectiveness of the plant-treatment formulation.

At 406, liquid reservoir 104 is at least partially filled with liquid 112. In some examples, the liquid reservoir 104 is filled with liquid 112 before depositing cartridge 202 at 404. In various embodiments, at least partially filling liquid reservoir 104 with liquid 112 occurs before or after reconnecting liquid reservoir 104 to plant-treatment product sprayer 100. For example, liquid reservoir 104 may be at least partially filled with liquid 112 by activating plant-treatment product sprayer 100, or by a user manually pouring an initial quantity of liquid 112 into liquid reservoir 104.

At 408, cartridge 200 is agitated while at least partially submerged in liquid 112 inside liquid reservoir 104. This may encourage the plant treatment formulation to exit pouch 202 and mix with liquid 112. In some examples, agitating cartridge 200 forces some liquid 112 to circulate through pouch 202, and entrain some of the plant-treatment formulation inside. In various embodiments, agitating cartridge 200 may include one or more of grasping and shaking pouch 202; grasping string 214 and repeatedly dunking cartridge 200 into liquid 112; shaking liquid reservoir 104 with liquid 112 and cartridge 200 inside, or submerging cartridge 200 into liquid 112 and stirring (e.g. with a stir-stick).

Still, in alternative embodiments, cartridge 200 is not agitated while at least partially submerged in liquid 112 inside liquid reservoir 104. In some cases, plant-treatment formulation 206 dissolves rapidly in liquid 112, such that pre-agitation is not required to ensure an adequate outflux of plant-treatment formulation from cartridge 200. In other cases, the cartridge 200 may be required to be positioned within the liquid reservoir 104 for a certain period of time to allow for the outflux of plant-treatment formulation from the cartridge 200 into the liquid reservoir 104.

It should be noted that the use of the cartridge 200 allows for accurate pre-measurement which encourages the correct usage of the pesticide in use as the users will not have to make any measurements of any ingredients to correctly use the pesticide.

It should be noted that the various cartridges described herein may be used with various sprayers. For example, a Miracle Grow sprayer systems with large orifices or the Gilmour Fertilizing Feeder Model No. 405 with a dial control for 4 different sprayer patterns was found to work well with the various cartridges described herein. Other example applications include submerging one of the various cartridges described herein into the liquid reservoir of a watering can, hand-held mister-type sprayer, and other irrigation systems. In some embodiments, the various cartridges described herein may be mixed into open soil or soil contained in a growing vessel (e.g. a container, pot, or planter).

While the above description provides examples of the embodiments, it will be appreciated that some features and/or functions of the described embodiments are susceptible to modification without departing from the principles of operation of the described embodiments. Accordingly, what has been described above has been intended to be illustrative of the subject matter described herein and nonlimiting and it will be understood by persons skilled in the art that other variants and modifications may be made without departing from the scope of the subject matter as defined in the claims appended hereto. The scope of the claims should not be limited by the preferred embodiments and examples, but should be given the broadest interpretation consistent with the description as a whole.

1. A cartridge for a liquid reservoir of a plant-treatment product sprayer, the cartridge comprising;
a liquid permeable pouch defining a pre-sealed internal volume; and
a plant-treatment formulation in the internal volume.

2. The cartridge of claim 1, wherein
the plant-treatment formulation comprises nematodes and a carrier formulation.

3. The cartridge of claim 1, wherein:
the liquid permeable pouch comprises a plurality of pores which provide the liquid permeability of the pouch, and
each of the plurality of pores is sized small enough to prevent passage of particles large enough to clog the sprayer.

4. The cartridge of claim 3, wherein:
a size of each of the plurality of pores is less than 2 mm.

5. The cartridge of claim 3, wherein:
a size of each of the plurality of pores is between 1.5 mm and 2 mm.

6. The cartridge of claim 1, wherein:
the pouch is flexible.

7. The cartridge of claim 1, further comprising:
a string extending from the liquid permeable pouch for handling the cartridge without touching the pouch.

8. The cartridge of claim 1, wherein:
the pouch comprises a woven material of fine filaments.

9. The cartridge of claim 1, wherein:
the pouch is biodegradable and comprises polylactic acid.

10. The cartridge of claim 2, wherein:
the nematodes comprise entompathogenic nematodes.

11. The cartridge of claim 1, wherein:
the plant-treatment formulation comprises at least one of a pesticide, a fertilizer, and a soil amendment.

12. The cartridge of claim 2, wherein:
the carrier formulation comprises vermiculite,

13. The cartridge of claim 1, further comprising:
a vapor-permeable packaging enclosing the pouch, the pouch being removable from the packaging prior to use.

14. The cartridge of claim 13, wherein:
the vapor-permeability of the packaging is provided by a hole pierced in the packaging and a remainder of the packaging is vapor-impermeable.

15. A method of providing a plant-treatment formulation to a liquid reservoir of a plant-treatment product sprayer, the method comprising:
depositing a cartridge into the liquid reservoir,
the cartridge including a liquid permeable pouch defining a pre-sealed internal volume, and a plant-treatment formulation in the internal volume; and
at least partially filling the liquid reservoir with a liquid,
the liquid permeating the pouch and carrying the plant-treatment formulation out of the pouch.

16. The method of claim 15, further comprising:
agitating the cartridge at least partially submerged in the liquid to encourage the plant-treatment formulation to exit the pouch with the liquid.

17. The method of claim 15, further comprising:
before depositing the cartridge, removing the cartridge from a vapor-permeable packaging enclosing the pouch.

18. The method of c aim 15, wherein:
the plant-treatment formulation comprises nematodes and a carrier formulation.

19. The method of claim 15, wherein:
the plant-treatment formulation comprises at least one of a pesticide, a fertilizer, and a soil amendment.

20. The method of claim 15, wherein:
the liquid permeable pouch comprises a plurality of pores which provide the liquid permeability of the pouch, and
each of the plurality of pores is sized small enough to prevent passage of particles large enough to clog the sprayer.

21. A cartridge for dispensing a plant-treatment formulation, the cartridge comprising:
a pouch containing the plant-treatment formulation, the plant-treatment formulation including one or more carrier components and one or more active components,
the pouch configured to filter the one or more carrier components and allow passage of the one or more active components.

22. The cartridge of claim 21, wherein:
the one or more active components includes a plurality of nematodes.
